(19) United States
(12) Patent Application Publication
(10) Pub. No.: US 2017/0004418 A1
(43) Pub. Date: Jan. 5, 2017

(54) SYSTEMS AND METHODS FOR IMPROVED ACCURACY OF TRANSIT RIDER COMMITMENTS AND NOTIFICATIONS

(71) Applicant: Trapeze Software ULC, Mississauga (CA)

(72) Inventors: Matthew Carl Goddard, Mississauga (CA); Wolfgang Stichling, West Kelowna (CA); Jarrod Clark, Burlington (CA)

(21) Appl. No.: 14/788,763

(22) Filed: Jun. 30, 2015

(51) Int. Cl. G06Q 10/02; H04W 4/02

(52) U.S. Cl. CPC G06Q 10/02; H04W 4/02

(57) ABSTRACT

Systems and methods for providing one or more client commitments to one or more clients, the client commitments relating to one or more client events on a demand response manifest to be performed by a transit industry vehicle, wherein each client event comprises a pick up or a drop off, a date, a time and an client event location. A mobile data terminal communicates with a real time traffic data provider and provides the received real time traffic dataset to a demand response scheduling server that determines any impact on the manifest the real time traffic data may have and hence whether a client commitment can be made, or an existing client commitment must be changed, and notifies the client of such client commitment or change.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Riders of demand response transit are often notified in advance of being picked up (for example “You will be picked up in 10 minutes”). It may be a desirable service for riders, and transit agencies like to provide notifications for client satisfaction and so riders are prepared for when they are picked up.

In ordinary course manifests use map information and various approaches to scheduling manifest events for a transit vehicle, and providing times when events are to happen. In practice these times often change based on real time information in performing the manifest, and sometimes even manifest events need to change. However, even though such real time information may be available it is not used to update rider notifications resulting in inaccurate notifications. Sometimes notification systems are actually abandoned as they are too inaccurate to be of value to riders and actually increase negative feedback to the transit agency. Inaccurate notifications can truly undo the benefit of the notification.

There thus remains a need for rider notifications to be updated based on real time traffic data.

### SUMMARY OF THE INVENTION

There is a system for providing one or more client commitments to one or more clients, the client commitments relating to one or more client events on a demand response manifest to be performed by a transit industry vehicle, wherein each client event comprises a pick up or a drop off, a date, a time and an client event location, the system comprising: a mobile data terminal (MDT), on the transit industry vehicle, configured to: make a real time traffic dataset request to a real time traffic data provider; receive a real time traffic dataset from the real time traffic data provider; submit the real time traffic dataset to a demand response transit scheduling server; a demand response transit scheduling server configured to: obtain the real time traffic dataset; determine, using the real time traffic dataset and the demand response manifest, whether any of the client events on the demand response manifest require an update; amend any of the client events on the demand response manifest that require an update; calculate whether a new client commitment can be made to a client for a client event on the demand response manifest; and if a new client commitment can be made to a client for a client event on the demand response manifest: notify the client of the new client commitment.

The mobile data terminal may be further configured to make a real time traffic dataset request to a real time traffic data provider in accordance with a dataset request algorithm.

The dataset request algorithm may increase the frequency of the real time traffic dataset request if a client commitment has been made for a future client event on the demand response manifest.

The real time traffic dataset request may comprise a location of the transit industry vehicle, and one or more client events that are part of the demand response manifest.

The demand response transit scheduling server may be further configured to calculate whether a new client commitment can be made to a client for a client event on the demand response manifest in accordance with a client commitment algorithm.

The demand response transit scheduling server may be further configured to confirm whether an existing client commitment has to be changed; and if the existing client commitment has to be changed: update the existing client commitment; and alert the client of the updated existing client commitment.

The demand response transit scheduling server may be further configured to notify the client of the new client commitment according to the client notification parameters of the client and notify the client of the updated existing client commitment according to the client notification parameters.

The update may comprise a new time or a new date.

There is also a method for providing one or more client commitments to one or more clients, the client commitments relating to one or more client events on a demand response manifest to be performed by a transit industry vehicle, wherein each client event comprises a pick up or a drop off, a date, a time and an client event location, the system comprising: making a real time traffic dataset request to a real time traffic data provider; receiving a real time traffic dataset from the real time traffic data provider; submitting the real time traffic dataset to a demand response transit scheduling server; obtaining the real time traffic dataset; determining, using the real time traffic dataset and the demand response manifest, whether any of the client events on the demand response manifest require an update; amending any of the client events on the demand response manifest that require an update; calculating whether a new client commitment can be made to a client for a client event on the demand response manifest; and if a new client commitment can be made to a client for a client event on the demand response manifest: notifying the client of the new client commitment.

The making may be further in accordance with a dataset request algorithm.

The dataset request algorithm may increase the frequency of the real time traffic dataset requests if a client commitment has been made for a future client event on the demand response manifest.

The real time traffic dataset request may comprise a location of the transit industry vehicle, and a portion of one or more client events that are part of the demand response manifest.

The calculating may be further in accordance with a client commitment algorithm.

The method may further comprise: confirming whether an existing client commitment has to be changed; and if the existing client commitment has to be changed: updating the existing client commitment; and alerting the client of the updated existing client commitment.

The notifying may be further according to the client notification parameters of the client and the alerting is further according to the client notification parameters.

The update may comprise a new time or a new date.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of a system for using real-time route information for demand response scheduling and transit-rider commitments and notifications according to a non-limiting embodiment of the present invention;

FIG. 2 is a method for using real-time route information for demand response scheduling and transit-rider commitments and notifications according to a non-limiting embodiment of the present invention; and

FIG. 3 is a further method for using real-time route information to update demand response scheduling and/or transit-rider commitments and notifications according to a non-limiting embodiment of the present invention;

FIG. 4 is a diagram of a demand-response manifest for demand response transit services according to a non-limiting embodiment of the present invention;

FIG. 5 is a method for using real-time route information for demand response scheduling and transit-rider commitments and notifications, showing the role of elements the system, according to a non-limiting embodiment of the present invention; and

FIG. 6 is a further method for using real-time route information for demand response scheduling and transit-rider commitments and notifications according to a non-limiting embodiment of the present invention.

### DETAILED DESCRIPTION OF THE INVENTION

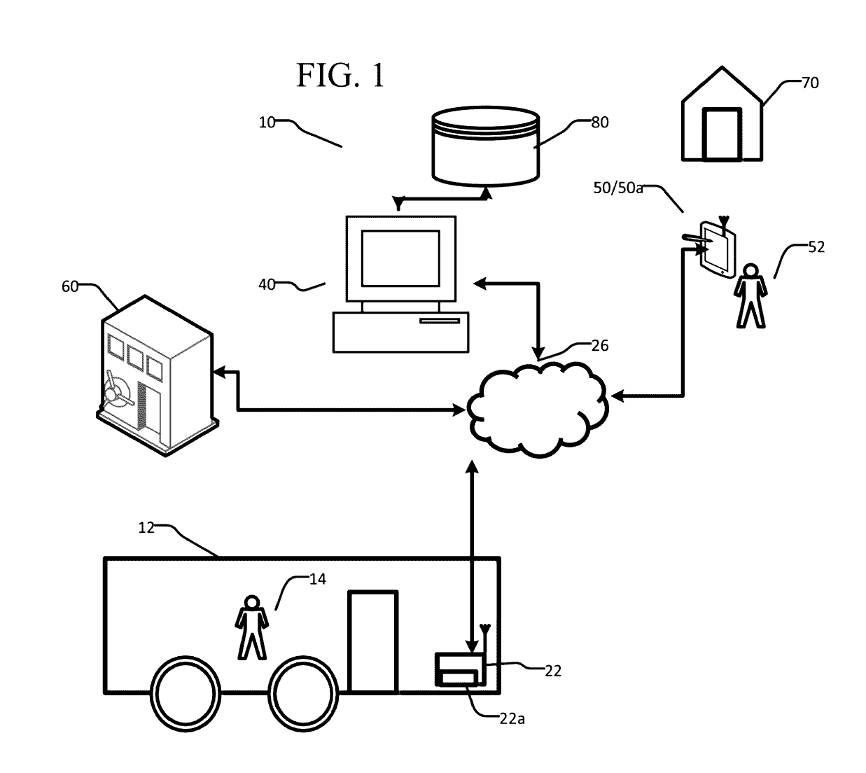

FIG. 1 is a diagram of a system 10 for using real-time route information for demand response scheduling and transit-rider commitments and notifications comprising transit industry vehicle (TIV) 12 having a TIV driver 14, further comprising mobile data terminal (MDT) 22 further comprising MDT application (MDTA) 22a, communication network 26, transit agency server 40, real time data provider (RTDP—or a real time traffic data provider) 60, rider home/location 70 where client 52 may be with their user computing device (UCD) 50 further comprising user computing device application (UCDA).

System 10 enables transit agencies (via transit agency server 40 and users thereof such as operators and/or schedulers) to provide more accurate commitments and notifications to clients 52 and better handle manifests/schedules for TIVs 12. Using system 10, the accuracy of, and confidence in, client commitments can be increased and the resultant notifications can increase rider satisfaction.

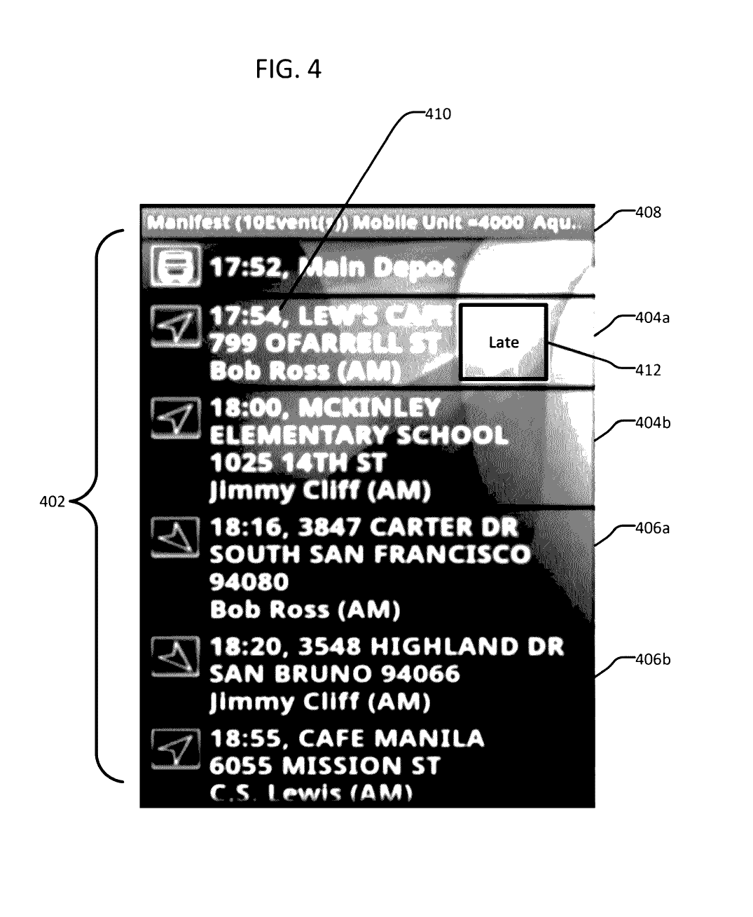

TIV 12 may receive a route to perform, such as a manifest 408 (also referred to herein as demand response manifest) of pickups (404a, 404b) and drop-offs (406a, 406b) as shown in FIG. 4. This may be from transit agency server 40 that may have a scheduling application thereon to create such manifests. TIV 12 may then begin performing the manifest 408. TIV 12 may rely on turn-by-turn driving instructions and may periodically receive real-time data about the route that it will travel. This real-time data may lead to on-board actions (by TIV 12, MDTA 22a, and/or TIV driver 14) to change the paths/streets taken to perform the route. This real-time data may further be provided to transit agency server 40, with or without the on-board actions, to enable various responses to real-time data, such as amended client notifications and amended manifests.

In one example of the operation of system 10, transit server 40 may provide an electronic demand response manifest (a series of demand response pickups and drop-offs, each referred to as a leg of the route/manifest or a client event, to perform on a given day, with target times to perform each leg of the run and various other client event parameters as described herein) to MDTA 22a. TIV 12 then begins to perform the manifest. In performing the manifest steps, TIV 12 may rely on turn-by-turn directions (via MDT 22 and MDTA 22a, which may be part of manifest 408 or RTTD but may be separate therefrom and may be presented visually and/or auditorily to driver 14) and may also query RTDP 60 for real-time data relating to the routes and/or streets/paths that TIV 12 is to take in performing its route/manifest. This may make it clear (directly or indirectly to MDT 22 and/or transit agency server 40) that TIV 12 will be late for the pickup that is to occur three legs later in the manifest (for example just after pickup 404a real time data may indicate that although legs 404b and 406a may be on time there is little chance that leg 406b will occur at 18:55). Real-time data received by MDT 22 may be provided to transit agency server 40. Transit agency server 40 may perform various calculations and/or update one or more client notifications or client commitments, using the real-time data from MDT 22, to increase the accuracy of client commitments and notifications. It may further update aspects of the manifest or future manifests.

Further detail will now be provided regarding elements of system 10.

Transit agency server 40 (also referred to herein as demand response scheduling server 40) may be at a transit agency, and may have further systems that form part of the overall system enabling one or more forms of transportation for a transit agency. Transit agency server 40 may allow supervisors or schedulers to determine (such as via scheduling functions), staff (such as via the creation of runs and assigning drivers) and monitor (such as schedule adherence, vehicle safety and performance, and the like) routes and manifests, vehicles and other assets and aspects of a transit agency. Demand response scheduling server 40 may determine, for example using the real time traffic dataset and the demand response manifest, whether any of the client events on the demand response manifest require an update (ie need their estimated times to be changed or even their date to be changed, for example). Transit agency server 40 may be implemented via one or more software components (including applications and database components, for example), hardware components (including processors, RAM, ROM and the like), and may be used by one or more transit agencies or fleet operators. An exemplary transit agency server may be PASS™ from Trapeze™.

Transit agencies may be agencies that have a transit network (generally a network of routes and coverage for the provision of transit services) and offer transit services. Transit networks may be definable via GPS coordinates, for example. Transit agencies may have registered demand-response riders and unregistered fixed route riders. Demand response riders may be able to schedule or book their client events via transit agency server 40, thus allowing them to request a pick up time. A transit agency may have a policy that specifies one or more of a pick up window or a drop off window (“event windows”—time periods of flexibility or buffers around the desired event time). This may allow a scheduling algorithm to perform more efficiently and seamlessly. For example, a policy of fifteen minutes on either side of a booked time—such that a client booking a 9:15 am pick up may be picked up between 9:00 am and 9:30 am. Different events, clients, vehicles, and the like, may have different event windows or there may be one primary event window. As such, client commitments may allow transit agencies to determine if client events will occur in event windows (or compare the client commitment to the event window), and also allow tracking of client commitments that are accurate and within event windows or not. Event windows may desirably be shortened, from a client perspective, but are beneficial for scheduling flexibility.

Notification database 80 may be a database that stores commitments and commitment data or parameters, notification data and notification settings or parameters, as described herein. Notification database 80 may be comprised of various pieces of hardware and may be distributed, as known to those of skill in the art. Notification database 80 may be in communication with scheduling server 40, either directly or via communication network 26. A “client commitment” is a commitment, with respect to a client's trip (their pick up and/or drop off), that the transit agency is making. It may be desirable for a transit agency to only make one client commitment to a client for a particular client event, and avoid changing or updating that client commitment. It may also be desirable for TIV 12 drivers to be aware of client commitments so that they can strive to achieve them and so their performance of the demand response manifest is good (particularly if an assessment of the number of client commitments they achieved is part of their appraisal). A client commitment may be determined via one or more client commitment algorithms and settings on scheduling server 40 and may then be communicated to the particular client and/or the client's driver (such as via MDT 22 or MDT 22a) via a notification or other communication that is either directed at a client or generally provided/transmitted. Each transit agency may specify the algorithms and parameters for establishing client commitments. Various factors may be considered before a commitment is made, such as the number of manifest events (stops) before the client event (pick up or drop off0 is to occur, the amount of time on the manifest before the client event is to occur, the distance before the client event is to occur, and any combination thereof. In one embodiment a client commitment is not determined until the client's event is the next event in the manifest, is estimated to be within twenty minutes of the present time, and real time traffic data has been considered within the last one minute. Client commitments may be tracked, for example in database 80, and may include various client commitment parameters with the client commitment (ie the date/time, client, vehicle, driver, route travelled to reach the client event, and the like). Such client commitment parameters may enable various reporting and tracking that may be used to improve system 10, such as: driver performance (once a commitment is made, how often does a particular driver achieve or “live up to” the commitment—as a percentage and/or as compared to other drivers that may even have performed similar manifests or client events using the same vehicle), client performance (how often does a particular client get “let down” by the transit agency not achieving the client commitment), client commitment algorithm/establishment (what parameters and/or algorithm should be used so that a suitable number/percentage of client commitments are achieved, while not reducing such client commitment to only one minute before TIV 12 reaches the client event—which would provide little value to the client or to the smooth and timely performance of the manifest). Of course other uses are considered within the scope of the present invention.

TIV 12 is a vehicle that provides, or relates to the provision of, transit services. TIV 12 may include buses, para-transit vehicles, maintenance vehicles, supervisory vehicles (such as cars or vans driven by supervisors) or a light rail/TRAM vehicles. TIV 12 has many systems running thereon, as known in the art, such as engines, brakes, audio announcement technology (such as transit stop announcements that may be displayed via next stop display 18 or announced via an audio announcement), signage, passenger counting, and the like (each a “TIV System”, not shown).

MDT 22 is a computing device that may take user input (such as keystrokes, clicks, touch inputs, and the like) and provides the user interface to functionality relating to the provision of transit services. MDT 22 may often be located on TIV 12, but may be removable therefrom. Exemplary MDTs 22 include mobile phones, tablets, laptops (that may be running Windows™ or iOS™ operating systems, for example), ruggedized laptops, vendor specific MDTs (such as Android™. Blackberry™ or Apple™ products). Each of these combinations of vendor and product type (laptop versus smartphone for example) may be considered a hardware platform for MDT 22. Operators of TIV 12, or supervisors, may be some of the primary users of MDTs 22. MDT 22 may communicate with other elements of system 10 (such as transit agency server 40, TIV 12, transit stop or transit station, kiosks, ticketing locations, and the like, which may be referred to herein as transit agency elements), for example via communication network 26. MDTs 22 may have GPS units therein, allowing MDT's 22 GPS location to be determined (which may be referred to as an MDT GPS location). MDT 22, and MDTA 22a may allow for turn-by-turn directions to be provided to perform manifest 408, such as GPS applications as are known to those of skill in the art.

MDT 22 may be operated by a driver of TIV 12. MDT 22 (such as via MDT-A 22a) may provide and/or allow a driver to provide the following functionality (noting that some of this functionality may be provided by RCD 50, or may be provided in conjunction with other elements of system 10):
(a) Perform the manifest 408 for TIV 12 (such as indicating that one or more legs of manifest 408 have been completed, optionally as they are completed;
(b) Acknowledge, to one or more RCDs 50 that TIV 12 on which MDT 22 resides has received their communication and will pick them up (though system 10 may separately do this, such as via transit agency server 40);
(c) Perform turn-by-turn transit navigation, such as via a GPS on MDT 22;
(d) Receive reports of damage on TIV 12, security events, and the like.

MDTA 22a is an application residing on MDT 22. MDTA 22a largely controls MDT 22, including its operation and communication with other aspects of system 10. MDTA 22a may be configured to present one or more screens (which may include output and input user interface elements) to a user of MDT 22, or otherwise accept or provide input or output (such as via sounds, vibrations, and the like) to enable to functionality described herein.

Communication network 26 may be substantially any public or private network, wired or wireless, and may be substantially comprised of one or more networks that may be able to facilitate communication between themselves. Communication network 26 allows elements of system 10 to communicate.

Rider location 70 may be any location that a rider 52 may be contacted. Rider location 70 may be a location that corresponds to a pick up or drop off location for a manifest, though it need not be (as rider 52 may be at location 70 but being picked up at another location 70). If rider 52 is to receive notifications that include real time data updates then location 70 may preferably in communication with system 10 via communication network 26.

Rider computing devices (RCD) 50 may be substantially any computing device (such as a tablet, mobile smart phone, laptop, etc) that allows a rider 52 to access and interact with system 10. In one embodiment, RCD 50 may simply be a home telephone. RCD 50 may have one or more applications thereon, including a rider transit application (RTA) that may provide functionality relating to the transit services of one or more transit agencies (such as trip planning, schedule adherence information, ticketing and fare payment, and the like). RCD 50 may have GPS technology (to allow RCD 50 to obtain its GPS location, which may be a rider GPS location), camera technology, and other technology available on such devices. RCD 50 and rider 52 may be referred to somewhat interchangeably herein; generally a rider/RCD pairing (ie that a rider 52 will have a RCD 50 that they will carry and use to interact with system 10) will mean that such references apply.

RCD 50 may allow rider 52 to:
(a) Schedule transit services (such as schedule trips for rider 52 to be provider);
(b) Receive notifications and updates about the status of the trip they are to take;
(c) Acknowledge they are taking a trip;
(d) Evaluate the experience of taking the trip;
(e) Cancel their trip/client event (perhaps due to their trip being too late to be valuable).

RCD-A 50a is an application that may reside on RCD 22. RCD-A 22a largely controls RCD 22, including its operation and communication with other aspects of system 10. RCD-A 22a may be configured to present one or more screens (which may include output and input user interface elements) to a user of RCD 22, or otherwise accept or provide input or output (such as via sounds, vibrations, and the like), to enable to functionality described herein. RCD-A 50a may be a computer program product, comprising a computer usable medium and having a computer readable program code thereon adapted to perform the functionality as described herein.

RTDP 60 may be a service that provides real time data and information about a particular route that is to be travelled. RTDP 60 may accept one or more legs or locations to travel between and determine a route to travel between them and provide real-time information about the route between the two points (such as traffic, weather or other disturbances). RTDP 60 may be, for example, a Google™ real time traffic service or a GPS-based service from Garmin™, TomTom™, or the like.

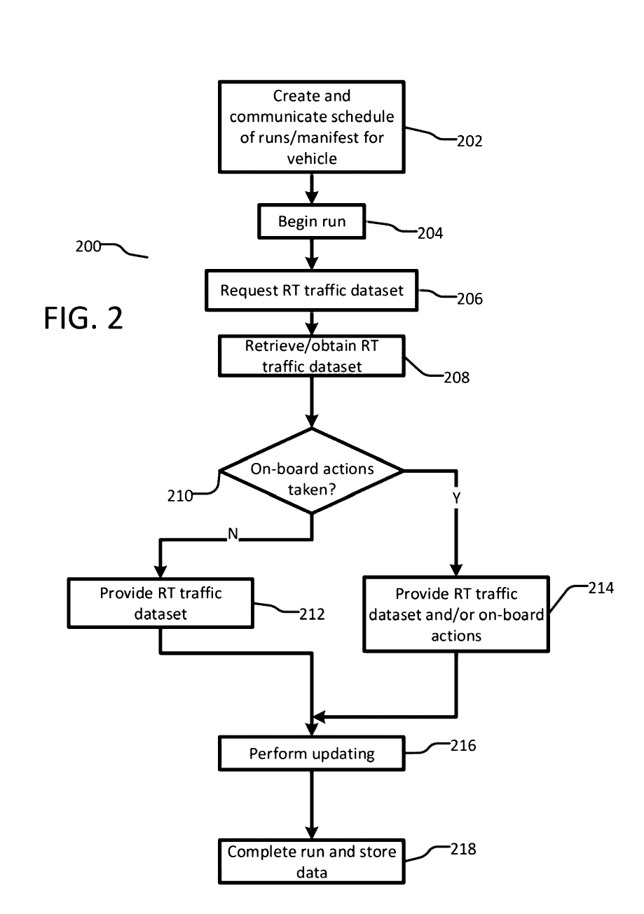

FIG. 2 is a method 200 for using real-time route information for demand response scheduling and transit-rider notifications according to a non-limiting embodiment of the present invention.

Method 200 may allow TIV 12 to perform its manifest, receive real time data relating to the route of its manifest, and use such real time data to i) update transit agency server 40, ii) update its route and iii) take on-board actions. Method 200 may be performed continuously, or periodically, during performance of a manifest. Various periods may be employed, for example based on where TIV 12 is performing its route (urban routes may require more frequent performance of parts of method 200, whereas suburban or rural routes may require fewer ‘updating’ of real time data). One or more RTDP 60 services may be used. Method 200 may be implemented substantially without changing a driver's performance of the run—not requiring them to interact with MDT 22 to send or receive data, make decisions about route changes, and the like.

Method 200 begins at 202 where a schedule of runs is created for a particular TIV 12. This may essentially comprise creating a demand response manifest made up of one or more client events (pick ups or drop offs of clients, having various parameters such as whether it is a pick up or a drop off, a date, a time, a manifest number that may identify its position in the demand response manifest, and an client event location), and may be performed by transit agency server 40, as known to those of skill in the art. The manifest may be sent to MDT 22, for example from transit agency server 40.

At 204 TIV 12 begins performing the run as set out in the manifest.

At 206 a request is made for a real time traffic dataset. This may be made by TIV 12 to RTDP 60, for example. In another embodiment scheduling server 40 may communicate with TIV 12 to ask or request TIV 12 to make such a request. Various triggers may cause scheduling server 40 to do so, including: upcoming notifications that scheduling server 40 wants to confirm are still substantially accurate (or accurate within a specified range) before sending them, lack of contact with TIV 12 for a period of time, manual triggers by a scheduler (like the client calls in to make a change, or the driver, changing request frequency/parameters after a client commitment is made or communicated to a client, and the like. Demand response scheduling server 40 and/or MDT 22 may execute one of several dataset request algorithms, involving one or more triggers, to determine when to make a real time traffic dataset request (RTTDR). In one embodiment the number of requests, or frequency thereof, may increase when a client event that has yet to be performed on the demand response manifest (a future client event) has already had a client commitment made to it, and optionally notified the client of the client commitment. The RTTDR may consist of several pieces of request data to send with the request, such as the manifest (or portions or some of the client events that remain to be performed), a current location (such as a GPS position), a status with respect to its current manifest (such as “on time”, “late” or “early”), a number of passengers on board, and the like. In one embodiment the portions of the manifest (client events) that are sent may be determined, for example, by the amount of time into the future the event is to occur (ie request real time data for each event that is to occur in the next thirty minutes, or the next sixty minute), the number of events (ie request information for the next three manifest events) or request all manifest events that are to occur before a particular manifest event (ie request information for all manifest events before John Smith is to be picked up).

At 208 a real time traffic dataset (RTTD) is retrieved or obtained. This may be by TIV 12 receiving the RTTD from TTDP 60, for example. The RTTD may comprise various pieces of traffic data to send with the dataset, such as estimated times for all manifest events based on the real time traffic data, an updated status suggestion, alternate routes for TIV 12 and its driver to consider (or simply the route that the real time data service provider is now instructing TIV 12 to take), other disturbances or events that may affect the performance of the manifest, and the like.

At 210 a determination is made whether any on-board actions have been, or are going to be, taken. On-board actions may comprise any action taken by TIV 12 that differ from that which is supposed to occur—based on the manifest or since the last RTTD was received. Exemplary on-board actions include a driver taking a new route to the next manifest event, a driver communicating with one of transit agency (via calling an employee thereof or interacting with transit agency server 40 such as via MDT 22) or riders 52 (such as via their RCD), or the like. Of course in some embodiments effectively no on-board actions may be taken as the driver simply follows the route (new and updated based on RTTD or unmodified) and is unaware of any changes thereto or not—they are simply following the route (turn by turn instructions for example) that was provided to their MDT 22 in RTTD.

If no on-board actions are taken at 210 then method 200 continues at 212 where the RTTD that was received by TIV 12 may be provided to transit agency server 40. TIV 12 may add further data to RTTD, such as a current GPS location, status, number of passengers, and the like—substantially any piece of data available to TIV 12 that may assist transit agency server 40 in performing the functionality described herein. The modified RTTD that TIV 12 provides to transit agency server 40 may be referred to as a vehicle provided RTTD and may include substantially any of the changes from the original RTTD as described herein.

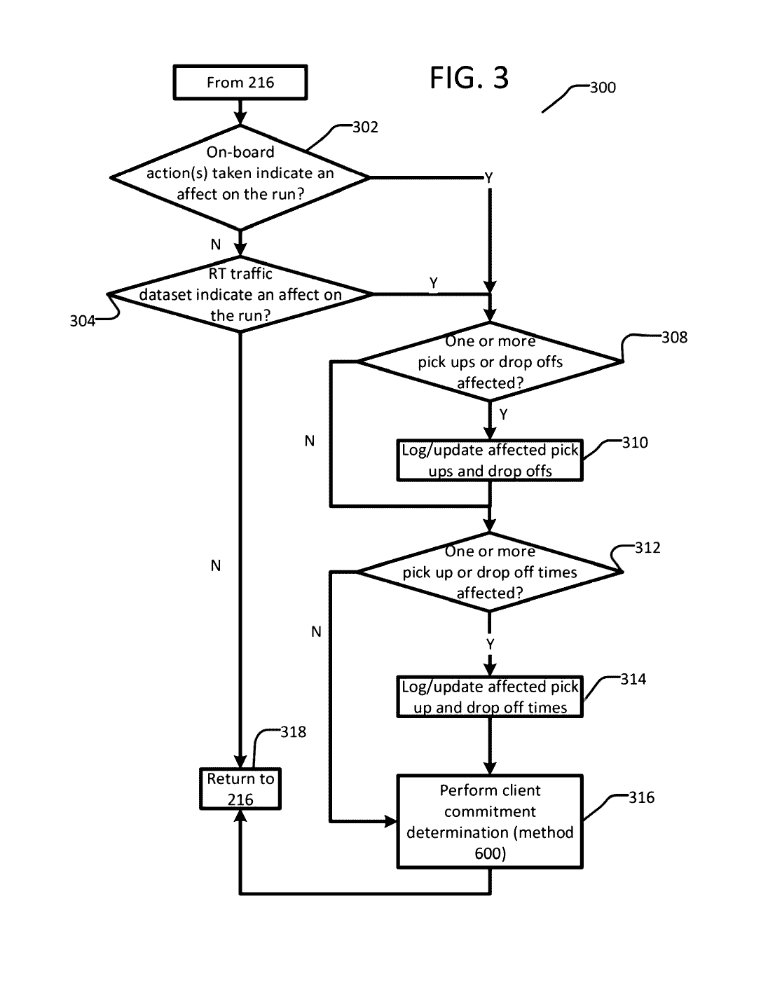

After 212, method 200 continues to 216, which may be substantially described in method 300 of FIG. 3.

Returning to 210, if on-board actions are taken then at 214 RTTD and/or the on-board actions may be provided to transit agency server 40. Similar to 212, TIV 12 may add further data to RTTD, such as a current GPS location, status, number of passengers, and the like—substantially any piece of data available to TIV 12 that may assist transit agency server 40 in performing the functionality described herein. If on-board actions were performed in 210, generally in response to conditions being observed by driver of TIV 12 (such as traffic issues, where driver was presented another route option and took it), such actions may be helpful for transit agency server 40 to be aware of. In one embodiment an on-board action may be for driver of TIV 12 to take an alternate route that may ensure TIV 12 is on time for the next event of a manifest. In such case RTTD may indicate that TIV 12 will be late for the next event of a manifest, but the on-board action (optionally with an updated RTTD that may be obtained via a separate request and response) may inform transit agency server 40 that TIV 12 will be on-time (thus a notification may indicate, for example, “Thanks to the driver's response to traffic, we are pleased to tell you that your vehicle will be at your pick up location on time.”).

After 214, method 200 continues to 216 to perform updating, substantially as in method 300 in FIG. 3. After updating, a run may be completed and data stored. This may involve storing data relating to the performance of the run, such as storing the client commitments and whether they were achieved, notifications that were sent, changes to the manifest, the number of changes and the nature of the changes that were made to the manifest, the estimate event times and the actual event times, and the like. This data may later be used by scheduling server 40 to achieve functionality described herein, such as reporting and monitoring.

FIG. 3 is a method 300 for using real-time route information to update demand response scheduling and/or transit-rider notifications according to a non-limiting embodiment of the present invention.

Method 300 may allow any updates, resulting from RTTD and/or on-board actions, to be performed by transit agency server 40. Method 300 may run continuously or may run when RTTDs are received.

Method 300 begins at 302 and 304 (the order of which may be interchangeable and may be performed by TIV 12 or by transit agency server 40) to assess whether either any on-board actions or the RTTD received (which may be from TIV 12) indicates an effect on the run being performed by TIV 12 (or any other runs or services that may rely on the run being performed by the TIV 12 that provided that RTTD and/or on-board actions. If neither of these assessments indicate an impact or effect, then method 300 continues to end at 306. Nothing is to be changed and all the client notifications, manifests, driver runs and shifts (for example drivers of TIV 12 may be prevented from finishing a manifest, that they were to finish, based on delays they are going to experience—hence a driver switch may be required or desired), etc, all remain the same. If either of these assessments indicate an affect then method 300 continues at 308.

At 308 an assessment is made whether pick ups or drop offs are affected—meaning that they will not be performed, or not be performed by the same TIV 12 as they were supposed to be performed by. If none are affected then method 300 continues to 312. If one or more are affected then method 300 continues to 310.

At 310 the affected pick ups and/or drop offs are logged and/or updated, which may result in one or more manifests 408 being updated (for one or more TIV 12). Such updating may include removing events from manifests, re-scheduling a particular event (for example a trip for a particular client, which may include a pick up and drop off) for a different TIV 12, and may include one or more notifications (such as to rider, driver of TIV 12, updating manifest 408 on MDT 22, and the like). This may substantially occur at transit agency server 40 and applications running thereon such as a demand-response transit application that may include a scheduling algorithm or application.

At 312 an assessment is made whether pick up or drop off times are affected. At 312 the query may simply be whether the times are affected, as opposed to 308 where the pick up and/or drop off may not be able to be performed. Based on the RTTD the scheduling algorithm may determine that TIV 12 is going to be late, or early, for a particular part of a trip. If none are affected then method 300 continues to 312. If one or more are affected then method 300 continues to 314.

At 314 the affected pick up and/or drop off times are logged and/or updated, which may result in one or more manifests 408 being updated (for one or more TIV 12).

The assessments at 308 and 312 may be made by a scheduling algorithm operating on transit agency server 40. As known by those of skill in the art, scheduling algorithms can determine that based on various factors (pick up and drop off locations, current position of TIV 12, current time, and real time data) a particular schedule or manifest 408 will not be able to be performed as intended—either that times will change or that the pick ups and drop offs scheduled to be performed by TIV 12 will be changed. The scheduling algorithm may determine that a particular pick up (noting that scheduling algorithm may be prevented from determining drop offs cannot be performed as riders need to be dropped off) cannot be performed by TIV 12 because, for example, the resultant drop off would be too late, another drop off would be too late, or the driver of TIV 12 is scheduled to stop their shift earlier than would be required to complete the manifest 408. Alternatively the scheduling algorithm may determine that a particular pick up or drop off cannot be performed on time, but that they can still be performed. The scheduling algorithm may then adjust manifest 408, for example by adjusting pick up and drop off times.

Method 300 then continues at 316 to perform client commitment determinations as described in method 600. Upon return from method 600, method 300 continues to 318 to then return to method 200 at 216.

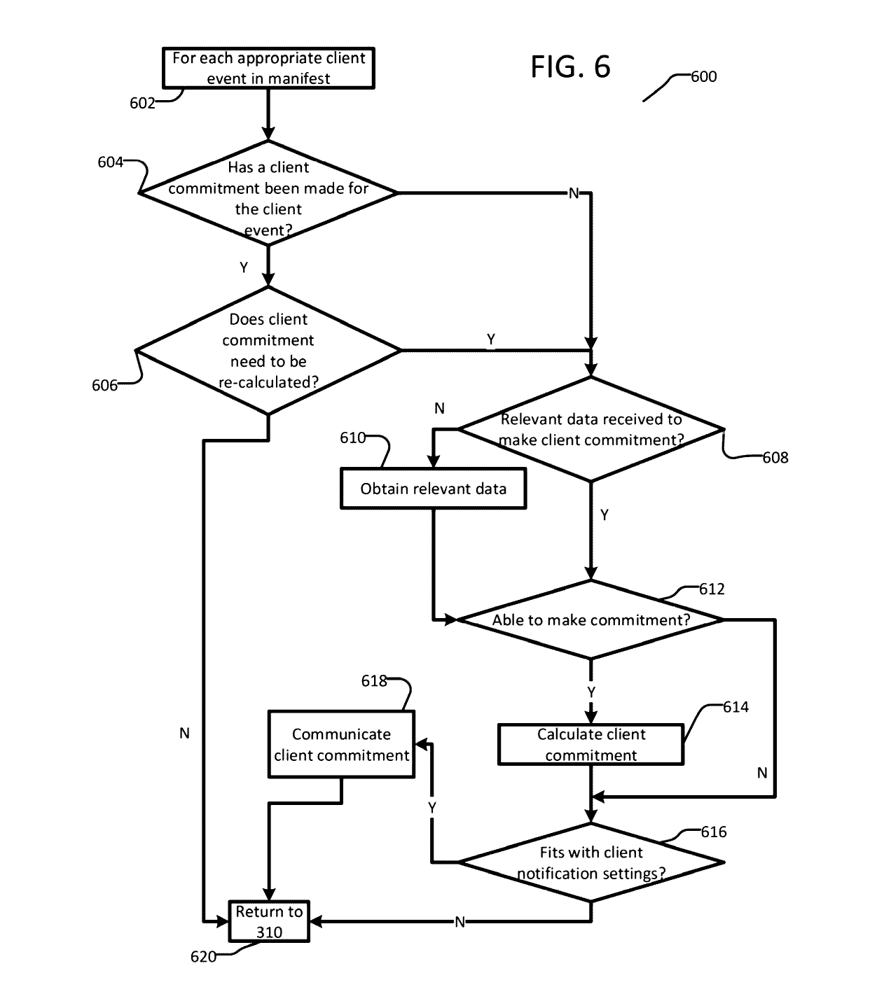

FIG. 6 is a further method 600 for using real-time route information for demand response scheduling and transit-rider commitments and notifications. Method 600 allows client commitments (also referred to as transit-rider commitments) to be determined, updated and communicated, according to optional client notification settings.

At 602 a loop begins, where method 600 is undertaken for each appropriate client event in the manifest. An appropriate client event may relate to a client that is on the manifest that also meets configurable parameters such as how many events in the future it is, how far into the future (time) it is, whether the manifest has changed, or the like. Determining appropriate client events may simply be away to save computation, for example.

At 604 a query is made whether a client commitment has been made (ie there is an existing client commitment, for example for a particular client event, as opposed to considering a new client commitment). If yes, method 600 continues to 606 where a query is made whether to re-calculate. If no re-calculation is necessary then method 600 ends at 620. If either a new calculation is required from 604 or a re-calculation is required then method 600 continues to 608 to query whether relevant data has been received to make a client commitment. This may include real time data, an updated manifest, and the like. If not all relevant data has been received then at 610 the relevant data is obtained (failure may simply end method 600).

Once all data is obtained, method 600 continues at 612 to determine whether a commitment can be made. This involves considerations described herein such as how many minutes in the future is the client event, how many events are to occur before it, and the like. The approach to determining whether a client commitment can be made may get more sophisticated and precise, and the confidence once it is made may increase. For example, by feeding data back into scheduling server 40 (such as in 218) it can be determined if the client commitment was achieved and how the actual times of the client events compared to the estimated times of the client events made when the client commitment is made. Tighter controls on when to make the determination may be implemented if the differences between actuals and estimates are too large at the time of making the client commitment.

If a client commitment can be made then it is calculated at 614. Then at 616 a query is made whether the client commitment calculated fits with client notification settings or parameters (for example if the client commitment is that TIV 12 will arrive in 20 minutes but a particular client only wants fifteen minutes' advance notice then it would not fit). If it fits, then at 618 the client commitment is communicated and method 600 continues to 620 to return to 310. This may involve setting various aspects of system 10 to make the phone calls, send the texts and emails, etc, as contemplated based on the notification settings, manifests 408 and RTTD/on-board actions. Note that client commitments may or may not include a TIV 12 identifier or any other way for the transit rider to know whether TIV 12 that is performing their event has changed.

If it does not fit then, at least for this iteration of method 600 the client commitment will not be communicated and method 600 continues to 620 to return to 310 (recalling that such method may occur often, as method 200 may occur often). Of course a transit agency may choose at any time to override client settings with transit agency policies.

Assessing, at 616, may involve referring to various data tables that may be stored in notification database 80 and/or memory by transit agency server 40, MDT 22 or the like.

Exemplary tables include Tables 1, 2, and 3.

TABLE 1
Manifest Based
Manifest A192

| | Event | | | | Notification |
|---|---|---|---|---|---|
| Event | (P/U, D/O) | Time | Rider | Notify? | Mode |
| 1 | P/U | 9:10 am | J. Smith | Y | Email, phone. |
| | | | | | Only late notices. |
| 2 | P/U | 9:25 am | A. Jones | Y | As per profile. |
| 3 | D/O | 9:50 am | A. Jones | Y | Verbal |
| 4 | D/O | 10:15 am | J. Smith | Y | Text |

Table 1 is an example of manifest-based notifications. In such case notifications may be stored/assembled or considered for each manifest. In such case each rider may have their own settings in the particular manifest (which may be pulled from a client profile, for example in Event 2). Events may either be pick ups (P/U) or drop offs (D/O), for example, the intended time and rider may be included, as well as whether to notify the rider and how to do so. Pick up notifications may be via one or more forms. The order may indicate to attempt to notify the rider in that order specified until the rider is reached. Drop offs may also have notifications so that riders are kept updated as they are on-board. They may still prefer to receive texts or verbal notifications (such as from driver of TIV 12). Notifications while on-board may be via MDT 22 and/or driver, as opposed to transit agency server 40 providing such notifications prior to rider being on board.

TABLE 2
Client Based
A. Jones

| | Event | | | | |
|---|---|---|---|---|---|
| | (P/U, | | Notification | | |
| Event | D/O) | Notify? | Mode | Exceptions? | Notes |
| 1 | P/U | Y | Email, | No early | Client is hard of |
| | | | phone. | notifications. | hearing. |
| 2 | D/O | Y | Text, | Only notify if | Notify doctor's |
| | | | verbal. | more than 10 | office as well. |
| | | | | minutes late. | |

Table 2 is an example of client-based notifications. In such case notifications may be stored for each client, akin to a notification profile. Referring back to manifest 408, if an event is changed or changing then Table 2 may be consulted to determine if any notifications exist that need to change. Such notification configurations may be accessed at any time by transit agency server 40 and/or MDT 22 (and may be stored in RAM or ROM in either). Exceptions may be specified, such as the client/rider does not want to be notified of early arrivals (ie usually there is traffic but today there is no traffic so TIV 12 will be early). Thresholds may also be set (ie only notify if TIV 12 will be more than 10 minutes late). Thresholds may be client specific or general across all clients for a transit agency, for example. Notes may help explain aspects of the notification profile for a rider, for example they are hard of hearing or they wish their doctor (at the drop off location) to be notified that they will be late.

TABLE 3
TIV Driver
Driver 123

| Notification | | | |
|---|---|---|---|
| Type | Notification | Notify? | Notification Mode |
| System | Exceeds | Y (driver | Email, phone. Only |
| | Block | and | lates. |
| | | supervisor) | |
| System | Affects | Y (driver | Email, phone. Only |
| | Other | and | lates. |
| | Manifests | supervisor) | |
| System | Danger of | Y (driver | MDT message |
| | missing | and | |
| | client | supervisor) | |
| | commitment | | |
| Driver | Exceeds | Y | As per profile. |
| Configured | Block | | |
| Driver | Issue | Y | As per profile. |
| Configured | | | |

Table 3 is an example of driver-based notifications. In such case notifications may be stored for each driver, akin to a notification profile. Such notification configurations may be accessed at any time by transit agency server 40 and/or MDT 22 (and may be stored in RAM or ROM in either). Driver notification types or events may include system types or driver configured. Exemplary system notifications may include i) a notification that the RTTD indicates the manifest or run will not be complete within an acceptable amount of time for the driver to have worked (for example in accordance with labor requirements or guidelines implemented by a transit agency, such as for run length, total time for a week, or the like) and ii) whether another run or manifest will be affected, which may be determined, for example, by determining whether a rider on TIV 12 is to be transferred to another TIV 12 or driver of TIV 12 is supposed to move to another TIV 12 (and perform another manifest). For system type notifications (or substantially for any notifications herein) multiple parties may be notified, for example transit agency server 40, a supervisor for the transit agency, and the like). Exemplary driver configured notifications may include exceeding a block or run (so that they may notify people they may be late or agree to work overtime, and the like) and issue notification (for example they want to know if there is a fire on the road, or an accident, but not just for general high volume traffic).

Of course it is to be understood that aspects of each of Tables 1, 2 and 3 may be combined as desired and other implementations of the design and storage of notifications are possible.

FIG. 4 is a diagram of a demand-response manifest 408 for demand response transit services according to a non-limiting embodiment of the present invention. Manifest 408 may include one or more events 402 in manifest 408 (such as pick ups 404 and drop offs 406), late notifications 412 (which may indicate that an event is going to be different from contemplated in the original manifest, various approaches to indicating of course are possible), time 410 (to indicate when the event is to occur).

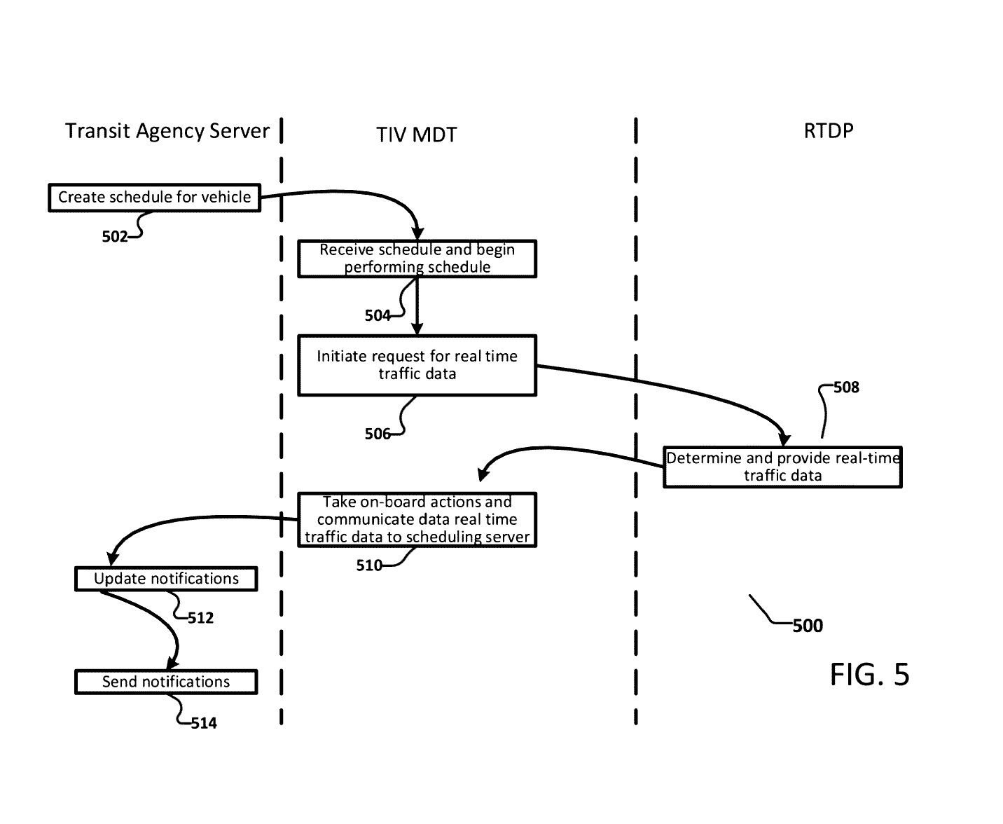

FIG. 5 is a method 500 for using real-time route information for demand response scheduling and transit-rider notifications, showing the role of elements the system, according to a non-limiting embodiment of the present invention. Method 500 may be one exemplary way to implement at least a portion of methods 200 and 300.

Method begins at 502 with transit agency server creating a schedule/manifest for TIV 12. The schedule/manifest is then provided to MDT 22. At 504 TIV 12 receives the manifest and beings performing it. At 506 TIV 12 requests real time traffic data. This may be triggered based on a regular interval, locations on a manifest, before each events is to occur (ie triggered from time 410), geographic directions (ie before each turn, before getting on a highway, and the like), or substantially any trigger that may signify that a change in real time traffic data may have changed or be changing. At 508 the request is received and a response is assembled and sent back to TIV 12. At 510 on-board actions may be taken at TIV 12 and RTTD and on-board actions may be assembled for communication to transit agency server 40. Then at 512 transit agency server 40 updates the notifications, which may be via parts of methods 200 and 300 (such as 210-214 and 308-314), and then transit agency server 40 may send notifications (which may involve asking driver of TIV 12 to notify on-board riders if such is specified in notifications).

It will be apparent to one of skill in the art that other configurations, hardware etc may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

What is claimed is:

1. A system for providing one or more client commitments to one or more clients, the client commitments relating to one or more client events on a demand response manifest to be performed by a transit industry vehicle, wherein each client event comprises a pick up or a drop off, a date, a time and an client event location, the system comprising:
a mobile data terminal (MDT), on the transit industry vehicle, configured to:
make a real time traffic dataset request to a real time traffic data provider;
receive a real time traffic dataset from the real time traffic data provider;
submit the real time traffic dataset to a demand response transit scheduling server;
a demand response transit scheduling server configured to:
obtain the real time traffic dataset;
determine, using the real time traffic dataset and the demand response manifest, whether any of the client events on the demand response manifest require an update;
amend any of the client events on the demand response manifest that require an update;
calculate whether a new client commitment can be made to a client for a client event on the demand response manifest; and
if a new client commitment can be made to a client for a client event on the demand response manifest:
notify the client of the new client commitment.

2. The system of claim 1 wherein the mobile data terminal is further configured to make a real time traffic dataset request to a real time traffic data provider in accordance with a dataset request algorithm.

3. The system of claim 2 wherein the dataset request algorithm increases the frequency of the real time traffic dataset request if a client commitment has been made for a future client event on the demand response manifest.

4. The system of claim 3 wherein the real time traffic dataset request comprises a location of the transit industry vehicle, and one or more client events that are part of the demand response manifest.

5. The system of claim 1 wherein the demand response transit scheduling server is further configured to calculate whether a new client commitment can be made to a client for a client event on the demand response manifest in accordance with a client commitment algorithm.

6. The system of claim 1 wherein the demand response transit scheduling server is further configured to confirm whether an existing client commitment has to be changed; and
if the existing client commitment has to be changed:
update the existing client commitment; and
alert the client of the updated existing client commitment.

7. The system of claim 6 wherein the demand response transit scheduling server is further configured to notify the client of the new client commitment according to the client notification parameters of the client and notify the client of the updated existing client commitment according to the client notification parameters.

8. The system of claim 1 wherein the update comprises a new time.

9. The system of claim 1 wherein the update comprises a new date.

10. A method for providing one or more client commitments to one or more clients, the client commitments relating to one or more client events on a demand response manifest to be performed by a transit industry vehicle, wherein each client event comprises a pick up or a drop off, a date, a time and an client event location, the system comprising:
making a real time traffic dataset request to a real time traffic data provider;
receiving a real time traffic dataset from the real time traffic data provider;
submitting the real time traffic dataset to a demand response transit scheduling server;
obtaining the real time traffic dataset;
determining, using the real time traffic dataset and the demand response manifest, whether any of the client events on the demand response manifest require an update;
amending any of the client events on the demand response manifest that require an update;
calculating whether a new client commitment can be made to a client for a client event on the demand response manifest; and
if a new client commitment can be made to a client for a client event on the demand response manifest:
notifying the client of the new client commitment.

11. The method of claim 10 wherein the making is further in accordance with a dataset request algorithm.

12. The method of claim 11 wherein the dataset request algorithm increases the frequency of the real time traffic dataset requests if a client commitment has been made for a future client event on the demand response manifest.

13. The method of claim 12 wherein the real time traffic dataset request comprises a location of the transit industry vehicle, and a portion of one or more client events that are part of the demand response manifest.

14. The method of claim 10 the calculating is further in accordance with a client commitment algorithm.

15. The method of claim 10 further comprising:
confirming whether an existing client commitment has to be changed; and
if the existing client commitment has to be changed:
updating the existing client commitment; and
alerting the client of the updated existing client commitment.

16. The method of claim 15 wherein the notifying is further according to the client notification parameters of the client and the alerting is further according to the client notification parameters.

17. The method of claim 10 wherein the update comprises a new time.

18. The method of claim 10 wherein the update comprises a new date.
